(19) United States
(12) Patent Application Publication
(10) Pub. No.: US 2003/0158057 A1
(43) Pub. Date: Aug. 21, 2003

(54) Cleaning material of color cathode ray tube panel and the cleaning method using the same

(76) Inventors: Yeoung Ku Kim, Kumi-shi (KR); Keun Pil Lee, Taegu-kwangyokshi (KR); Kyoung Ryul Lim, Taegu-kwangyokshi (KR)

Correspondence Address: BIRCH STEWART KOLASCH & BIRCH, PO BOX 747, FALLS CHURCH, VA, 22040-0747, US

(21) Appl. No.: 10/137,411

(22) Filed: May 3, 2002

(30) Foreign Application Priority Data
Feb. 21, 2002 (KR) P2002-9240
Mar. 22, 2002 (KR) P2002-15508

(51) Int. Cl. B08B 3/08; B08B 3/12; C11D 1/00

(52) U.S. Cl. 510/108; 134/34; 134/1; 134/26; 134/28

(57) ABSTRACT

A cleaning material of a color cathode ray tube panel is disclosed, which comprises an acidic water-soluble solution and a surfactant, and a cleaning method conducted by using the same and by way of at least one selected from spray manner, supersonic application or dipping method.

This application claims the benefit of the Korean Application Nos. P2002-9240 and P2002-15508 filed on Feb. 21, 2002 and Mar. 22, 2002, respectively, which are hereby incorporated by reference.

### BACKGROUND OF THE INVENTION

1. Field of the Invention

The present invention relates to a cleaning material for color cathode ray tube panels and a cleaning method by using the same, and more particularly, to a cleaning material for the color cathode ray tube panels and a cleaning method accomplished by a weak acidic cleaning material and at least one selected from a spray method, a supersonic cleaning method or a dipping method to remove graphite film, fluorescent film and/or metallic reflection film of poor panels generated during production of the color cathode ray tube to regenerate the panels.

2. Discussion of the Related Art

Generally, a color cathode ray tube generates an electron beam by an electron gun in a neck section of the tube, which makes it possible to deflect the electron beam up and down and right and left by means of a deflection yoke and to pass the deflected beam through a slot of a shadow mask thereby to select colors; and reproduces image signals by impacting the selected electron beam against a fluorescent film inside the panel to emit light.

In a process for producing such color cathode ray tube, there are caused defects and/or failures in quality of the tube during a general application process such as graphite (black matrix) application, blue and red color fluorescent materials application, photo-resist exposing and/or developing processes, intermediate layer (lacquer) application, metallic reflection film (aluminum film) application or so forth. The produced poor panels are not instantly discarded but under a process for removing the materials including the graphite, the fluorescent film, the intermediated layer, the metallic reflection film generated inside of the panel and forwarded to further use. Such panel comprises Si—Si and/or Si—O—Si bonds as the strong covalent bond between Si components.

Priory known materials for cleaning a color cathode ray tube and cleaning methods by using the same will be followed in detail, by way of the accompanying drawings.

FIG. 1 illustrates a cleaning process by using any common solvent according to one of conventional methods. With reference to FIG. 1, a subject 101 to be removed contacts a solvent 102 and the contacted portion 103 to remove it from the subject 101; the contacted portion 103 being emulsified by the solvent 102 to form a precipitate 104. Such method is to repeatedly remove adhered materials from the subject 101 until the entire subject becomes the precipitate 104 thereby to achieve the cleaning effect.

FIG. 2 illustrates a conventional cleaning process performed by using caustic alkali and strong acid. With reference to FIG. 2, the subject 101 contacts and is combined with the strong acid or the corrosive alkali 150. Then, the combined subject 101 is emulsified to form a non-decomposable precipitate 151. In other words, such cleaning process is carried out in a way of etching organic components.

For example, for a purpose of removing the fluorescent film and the graphite, previous cleaning materials for the color cathode ray tubes generally comprise a strong acid such as fluoric acid and the panel has been washed in a high-pressure spray form process. However, among glass components silica does not react with a weak acid but with F⁻ ions as a strong Lewis base to form SiF₆²⁻ ions. Such reaction may be expressed in a following scheme;

SiO₂(s)+6HF---->SiF₆²⁻(aq)+2H₃O⁺(aq)

Alternatively, the silica can also chemically react with OH⁻ as a Lewis base in a hot molten sodium hydroxide and O²⁻ as another Lewis base group of a carbonic anion in sodium carbonate fusion. Therefore, such glass component is removed rather than washed by the fluoric acid. Otherwise,

nHF+SiO₂---->SiF₄+2H₂O+nH+n F

2HF+SiF₄---->H₂SiF₆

In the above reaction schemes, the unreacted HF is discharged in gas form. H₂SiF₆ spoiled on surface of the glass has a difficulty of being removed and, in case of residual H₂SiF₆, causes viscosity of the entire chemicals contained in a fluoric acid tank to greatly affect a reduction of life-time of the chemicals. When such acids and corrosive bases are employed as the cleaning material, it is generated a non-decomposable sludge by emulsification of the chemicals and it is removed the material formed on surface of the glass by bonding the material with H⁺ ions of the acids thereby to lead amount of H⁺ ions to be reduced, in turn, to increase pH value and aging of the cleaning material so that ability of the cleaning material may be sharply lowered.

Accordingly, the high-pressure spray manner causes economical problems because it demands large amount of the cleaning material to be continuously substituted and/or introduced into the cleaning tank; the strong acids and the corrosive bases in the cleaning material are very harmful to human body and form rust on equipment and metal parts concerned; and it violates environmental regulations, whereby it requires a specific refinement installation.

Furthermore, ammonium fluoride based cleaning materials and/or such materials together with inorganic acids, particularly, phosphoric acid may be utilized as the cleaning material. Similarly, the possible cleaning time may be reduced by the ionic reaction to result in a rapid aging of the chemical; and even the removed materials may deposit to the surface of the glass again. However, a glass etching capability of the cleaning material is extremely weak compared to the fluoric acid. Therefore, the cleaning material can a reduced performance of removing defects of material for the glass panel itself, some grooves and/or pits protruded less than the fluoric acid. Consequently, if there are remained some of pits after cleaning, it may be generated dot failures in a process of applying graphite or fluorescent film due to the residual pits and to lead severe problems in quality of products. Accordingly, when utilizing the fluoric acid, it involves problems concerning environmental condition, safety and/or applicability while another problems such as reductions of quality and production being caused by pits of the glass surface in case of adapting ammonium fluorides as the cleaning material.

If any of fluoric acid, ammonium fluoride and phosphoric acid as the cleaning material is used in a form of high-pressure spray, the cleaning material and the cleaning method for the color cathode ray tube have problems as follows:

First, in case of using the fluoric acid, it allows surface of a substrate to be cut by the etched panel surface and causes a severe damage to the panel and reduces the cutting property of the cleaning material for the graphite and the fluorescent film.

Second, an irregular pH film is formed by the irregular cutting process.

Third, it requires repair of the production line or installation owing to coagulation of silicates as the precipitate.

Fourth, it accelerates corrosion of the production line or installation.

Fifth, circumstance conditions for the cleaning work are unstable.

Sixth, it incurs costs for treatment of waste water generated by formation of fluorine ions.

Seventh, the reduction of quality and production ability is lowered due to pits of the glass surface.

### SUMMARY OF THE INVENTION

Accordingly, the present invention is directed to a cleaning material for a color cathode ray tube panel and a cleaning method by using the same that substantially obviates one or more problems due to limitations and disadvantages of the related art.

An object of the present invention is to provide a cleaning material for a color cathode ray tube panel and a cleaning method by using the same which comprise using a mixed weak acid cleaning material in order to remove poor pits of glass surface; to alleviate etching of panel; to reduce corrosion of installation, irritation to human body and danger of a burn; and to permit a simple and easy treatment of waste water; and to easily accomplish a cleaning process by at least one of a spraying cleaning process, a supersonic cleaning process or a dipping method.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve the above object and other advantages and in accordance with the purpose of the invention, as embodied and broadly described herein, a cleaning material for the color cathode ray tube comprise an acidic water-soluble solution and a surfactant and the cleaning method is performed by means of at least one selected from the spraying cleaning process, the supersonic cleaning or the dipping method.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a cleaning process by using any solvent according to one of conventionally known methods;

FIG. 2 illustrates another cleaning process by using both of alkali and strong acid according to alternative one of the known methods;

FIGS. 3a and 3b illustrate a cleaning process by using a specific cleaning agent according to the present invention;

FIG. 4a illustrates an enlarged photograph of an inferior panel;

FIG. 4b illustrates another enlarged photograph of a panel produced by using any of conventional cleaning agents; and

FIG. 4c illustrates an enlarged photograph of a panel produced by using a specified cleaning agent according to the present invention.

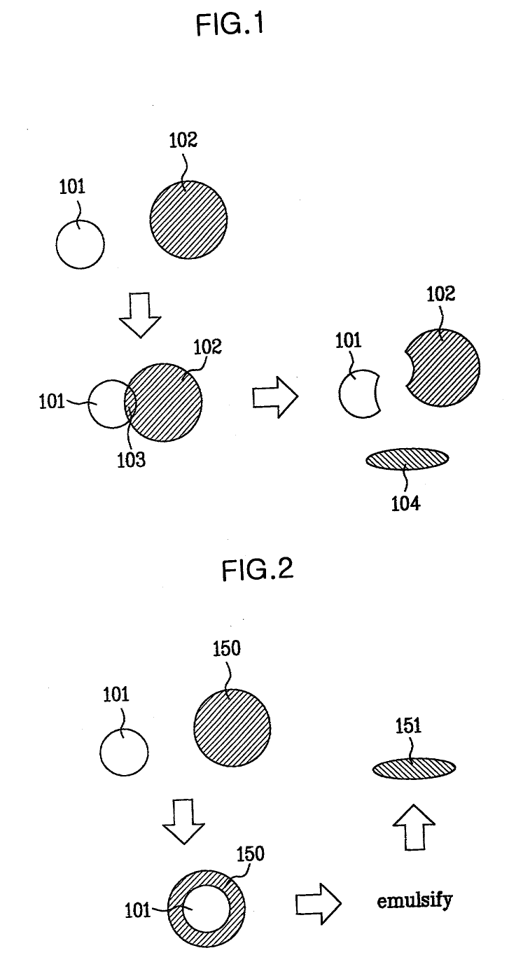

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention provides a cleaning material and a cleaning method for reproducing a color cathode ray tube panel by the same, which are to remove a fluorescent film, a graphite film, an intermediate layer and a metallic reflection film adhered to the panel. LG-Cleaner (trade name) as a mixed acidic water-soluble cleaning material according to the present invention has a composition shown in Table 1 as follows:

TABLE 1
composition of LG-Cleaner as the cleaning material

| Component | Content (wt %) | Function |
|---|---|---|
| Water | 50 | Water-soluble solution |
| Ammonium fluoride | 22 | Stimulation of Si covalent |
| | | bonding |
| Phosphoric acid | 13 | Ammonium fluoride assistant |
| Nitric acid | 7 | Activation of acidic solution |
| Sodium fluoride | 4 | Etching of glass surface |
| Surfactant | 3 | Removal of surface tension |
| builder | 1 | Preservation of function of |
| | | surfactant |

The above cleaning material has about pH 2 to 5 and a specific gravity of 1.0 to 1.5.

Here, it is possible to obtain a good result even by preparing the cleaning material with any of inorganic acids such as nitric acid, hydrochloric acid or sulfuric acid selected in place of the phosphoric acid.

More particularly, the present invention is characteristic of using the ammonium fluoride instead of fluoric acid; using any inorganic acid to reduce acidity of the ammonium fluoride without reduction of the cleaning capability; and using a specific surfactant to serve the fluorescent film, the black mattress film or the intermediate layer to come off and be removed from the glass surface. Further, the builder has a role of assisting the surfactant to be steadily used under the acidic condition. The above cleaning material has specific compositions as follows:

Composition 1 comprises 3 to 30% by weight of ammonium fluoride, 1 to 25% by weight of inorganic acid, 1 to 10% by weight of sodium fluoride, 1 to 10% by weight of surfactant and trace of builder in a water-soluble solution.

Composition 2 comprises 5 to 30% by weight of ammonium fluoride, 1 to 25% by weight of inorganic acid and 1 to 10% by weight of surfactant in a water-soluble solution;

Composition 3 comprises 5 to 30% by weight of ammonium fluoride and 1 to 25% by weight of inorganic acid in a water-soluble solution; and

Composition 4 comprises 5 to 30% by weight of ammonium fluoride and 1 to 20% by weight of surfactant in a water-soluble solution.

Among the respective compositions, the inorganic acid includes, but is not limited, at least one or preferably two or more selected from the nitric acid, the phosphoric acid, the sulfuric acid and the hydrochloric acid. Amount of the inorganic acid is about 1 to 25% by weight, preferably 5 to 30% by weight. If different inorganic acids together are applied, it is activated an etching process of the glass as a synergistic effect of a mixed acid comprised of selected inorganic acids and the ammonium fluoride and the sodium fluoride, thereby to improve a performance of removing pits on the glass surface.

If the amounts of the ammonium fluoride and the sodium fluoride are below the above determined range an ability to eliminate the graphite component is lowered, whereas the amounts are above the range, produced are metallic salts to inhibit a rinsing process from being actively conducted and to generate poor products having defects. Alternatively, if the amount of the inorganic acid is below the defined range above, activation of the fluorine ions is not sufficient to lead reduction of the cleaning efficiency, whereas the amount is above the range the metallic salts are formed to make the rinsing to be inactive and to generate the poor products. Furthermore, if the amount of the surfactant is below the specified level the subject to be removed may re-adhere to the glass surface, whereas it is above the level the rinsing is difficult and the poor products are produced during the cleaning material application process.

Each of the respective compositions is diluted by 5 to 20 times in a pure water to form the cleaning material and shows the cleaning efficiency shown in the table 1. It shows that the most excellent efficiency is obtained by applying the Composition 1. Also, the cleaning materials of all of the compositions have pH 2 to 5 and a specific gravity of 1.0 to 1.5.

Various properties of the cleaning materials with the respective compositions are listed in Table 2;

TABLE 2
properties of cleaning materials with
respective compositions

| | | Result after | |
|---|---|---|---|
| Type | components | cleaning | Remarks |
| Composition 1 | Ammonium fluoride | Fine cleaning, | At least one |
| | 3-30 wt %, | fine pit removal, | or preferably |
| | inorganic acid 1- | Reinforced rinsing | two or more |
| | 25 wt %, sodium | against stain | inorganic |
| | flouride 1-10 wt %, | failure, excellent | acids |
| | surfactant 1- | reduction of | selected |
| | 10 wt %, trace of | cleaning time | from nitric |
| | builder in water | | acid, |
| | soluble solution | | phosphoric |
| | | | acid, sulfuric |
| | | | acid or |
| | | | hydrochloric |
| | | | acid; effect |
| | | | of mixed |
| | | | acid |
| Composition 2 | Ammonium fluoride | Fine cleaning, | Improved |
| | 5-30 wt %, | partial generation | reaction to |
| | inorganic acid 1- | of pit defect, | Si by con- |
| | 25 wt %, surfactant | excellent | trolling |
| | 1-10 wt % in water | reduction of | content of |
| | soluble solution | cleaning time | ammonium |
| | | | fluoride |
| Composition 3 | Ammonium fluoride | Partial unremoval | Liquid |
| | 5-30 wt %, | at cleaning, | com- |
| | inorganic acid 1- | chemical-aging | pensation |
| | 25 wt % in water | acceleration, re- | at reduced |
| | soluble solution | adhesion of | cleaning |
| | | removed material | ability |
| Composition 4 | Ammonium fluoride | Partial unremoval | Control of |
| | 5-30 wt %, | a cleaning, | content of |
| | surfactant 1- | partial generation | ammonium |
| | 20 wt %, trace of | of pit defect, | fluoride |
| | builder in water | excellent | for improve- |
| | soluble solution | reduction of | ment of |
| | | cleaning time | cleaning |
| | | | ability |

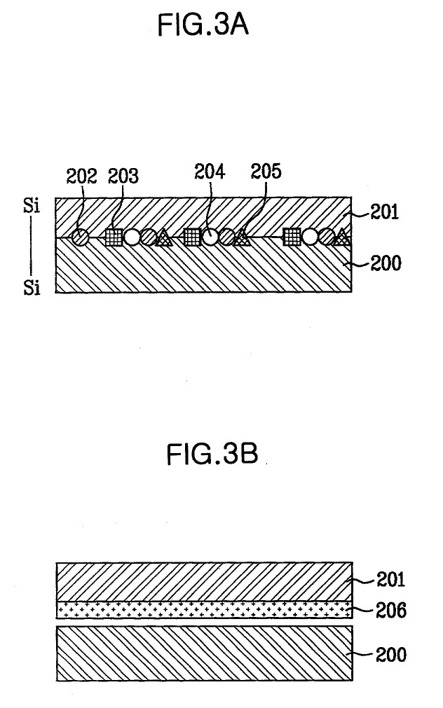

FIGS. 3a and 3b illustrate a cleaning process according to the present invention.

As shown in FIG. 3a, ammonium fluoride 202, nitric acid 203, phosphoric acid 205 and sodium fluoride 204 are penetrated between a panel 200 and a black mattress 201. The ammonium fluoride 202 irritates Si—Si or Si—O—Si covalent bond of surface of the panel between the above panel 200 and the black mattress 201 to strip off Si component. The phosphoric acid 205 among the inorganic acids reacts as an assistant of the ammonium fluoride 202 and shakes a molecular structure of the surface of the glass panel to be weaken. The nitric acid 203 also activates the roles of the ammonium fluoride 202, the phosphoric acid 205 and the sodium fluoride 204. Such sodium fluoride 204 reacts with the surface of the glass panel to induce etching state and to smoothly cut the surface.

Referring to FIG. 3b, the surfactant 206 penetrates between the panel 200 and the black mattress 201 to eliminate the surface tension and to make it possible to remove the black mattress 201 from the panel 200 by means of acidic solution. The builder 207 assists the reaction of the surfactant 206. The surfactant 206 inhibits the removed materials from being adhered again to the glass surface.

In such case, the surfactant 206 is generally useable in the cleaning material and includes, but is not particularly limited to, at least one selected from a group consisting of alkylbenzene sulfonate, sodium xylene sulfonate, glycol ether, or fatty salts, alkyl sulfonate, α-olefine sulfonate and α-sulfonic fatty acid methylester. Also, among non-ionic surfactants an oxo-alcohol polyetheneglycol ether or a fatty alkanolamide or the like is preferably used.

The builder includes, but is not specifically limited to, diethylene glycol ether, diethylene butyl glycol ether, carbonates such as sodium carbonate or sodium hydrocarbonate, sodium silicate, silicates with a layered structure, sulfate, carboxylmethyl cellulose, polyethylene glycol, polyvinyl alcohol, polyvinyl polydon, polyacric acid, maleic acid, vinylether copolymers or etc.

The cleaning material according to the present invention can break the surface tension between the panel and impurities (that is, the black matrix to be removed); make the ammonium fluoride and the inorganic acid and the sodium fluoride to penetrate between the surface of the panel and the black mattress and to stimulate Si—Si or Si—O—Si covalent bonds on the panel surface positioned between the panel and the black mattress, and divide the impurities from the panel.

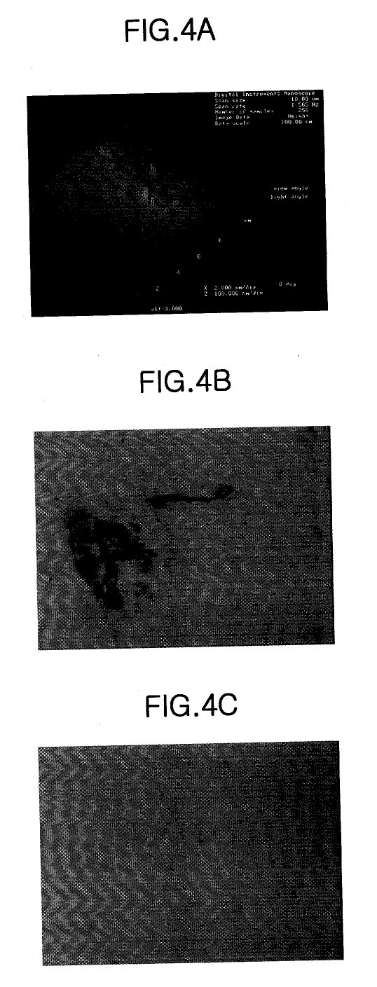

FIG. 4a is an enlarged photograph of a poor panel, FIG. 4b is another enlarged photograph of a panel cleaned by using any conventional cleaning material, whereas FIG. 4c is the other enlarged photograph of a panel by using the specified cleaning material according to the present invention.

As shown in FIG. 4a, there were pits projected on the glass surface or material defects. Such pits should be etched to form a smooth surface and to protect failures during the cleaning material application.

Referring to FIG. 4b, it found that the glass panel treated by a mixture of the ammonium fluoride and the inorganic acid or the ammonium fluoride only, as the common cleaning material still has faults and/or defects protruded on the surface thereof.

FIG. 4c which is the enlarged photograph of the glass panel treated by the cleaning material according to the present invention shows that projections on the surface of the glass panel have been completely eliminated by the mixed acidic solution and the inorganic acid. Therefore, failure in quality of product caused from the glass material is remarkably reduced.

Besides, in order to produce the cleaning efficiency, it may be added to the glass panel with a physical stress. The physical stress serves the penetration of materials including the surfactant, the acidic solution such as the ammonium fluoride and the inorganic acid such as nitric or phosphoric acid into the panel, and the physical stress is applicable by way of spray, supersonic or dipping processes or so forth.

After cleaning with the cleaning material of the present invention, the panel was observed for difference of surface roughness in the following Table 3.

TABLE 3
Difference of surface roughness after cleaning

| | Fluoric acid | LG-Cleaner |
|---|---|---|
| Ra | 0.148 | 0.125 |
| Rz | 0.77 | 0.625 |

Ra: (integrated) area between a ridge and a valley formed inside the panel by etching.

Rz: distance between a ridge and a valley formed inside the panel by etching.

As shown in FIG. 3, the cleaning material according to the present invention expresses the cleaning capability substantially identical to that in the case when using the fluoric acid as the common cleaning material; has only a small difference of surface roughness due to the cut state of the glass inside the panel because no etching is conducted on the glass substrate by the fluoric acid; and represents the etched condition with a decrease of about 20% compared with common cases when measuring the ridges and the valleys inside the panel. A result of evaluating characteristics of the screen after cleaning it with the cleaning material according to the present invention is shown in the following Table 4.

TABLE 4
Evaluation of characteristics of screen;
brightness and contrast

| | Fluoric acid | | LG-Cleaner | |
|---|---|---|---|---|
| Brightness | 25.3 | fL | 26.4 | fL |
| Contrast | 28.2 | | 27.5 | |
| BCP | 4.935 | | 5.128 | |

As shown in the above table 4, the screen treated by the cleaning material and the cleaning method according to the present invention shows the characteristics substantially same to that obtained by using the fluoric acid.

For content of F⁻ ions contained in the cleaning material according to the present invention, it was found out that the cleaning material has a noticeably reduced concentration of the F⁻ ions compared to the fluoric acid, thereby, can save amount of the cleaning material required at treatment of waste water involving the fluoric acid. Furthermore, the cleaning material of the present invention has a benefit of extremely reducing harmfulness to human body.

The following table 5 represents measurement values of Primary Irritation Index (P.I.I.) of the inventive cleaning material and the common cleaning products as the control.

TABLE 5

| | | Inventive cleaning |
|---|---|---|
| P.I.I | Common products | material |
| | 4.5 medium degree, | 1.4 weak irritation |
| | strong irritation, | |
| | severe edema and skin | |
| | erosion | |

In the above table 5, P.I.I. which is a standard for determining harmfulness of chemicals to a human body is estimated to represent a weak irritation influence in case of the cleaning material according to the present invention.

The present invention will be illustrated in detail with reference of the following examples.

### EXAMPLE 1

### Spray Manner Cleaning Method

The cleaning material according to the present invention was applied to remove the fluorescent film, the graphite film and the intermediate layer and the metallic reflection film attached to a panel in a process of cleaning and reproducing the panel by means of a spray apparatus. The cleaning material had a trade name of LG-Cleaner with 10% content, and was applied to the panel at room temperature. With regard to the spray apparatus, it requires a nozzle to be designed to inject the cleaning material and to sufficiently wet the subject to be removed and, preferably to have 1 Kgf/cm² or more of nozzle pressure to cause cracks on the subject and/or to ensure a full contact between the cleaning material and the panel made of glass. The apparatus also preferably provides a physical stress sufficient to cut and remove projected pits on surface of the glass panel by providing a proper pressure and arranging the nozzle to be located at a specified angle.

In addition, the panel to be cleaned rotates and is under a regular cleaning process, which comprises the rotation rate specifically designed in consideration of process index, intensity of injection pressure from the nozzle, distance between the nozzle and the subject or the like. Number of processes and time for applying the cleaning material per process should be managed and/or defined to an appropriate level on the basis of kinds of the cleaning materials, the subject, or a reactive relation of the cleaning material to material of the subject, for example, glass. In case that the application time of the cleaning material is short, the cleaning material may be not combined with the subject sufficient to react, in turn, to remove the subject from the panel. For example, the metallic reflection film demands constant period of time. Moreover, because the cleaning material is an acidic solution, therefore, it is concerned that the cleaning material excessively etches the glass panel to induce a poor quality of internal and external sides of a product, that is, the color cathode ray tube if it exceeds a certain period of time, whereas the cleaning material may not eliminate pits on the glass surface if it does not come up to the time.

During or after the application of the cleaning material, there is conducted a rinsing process by utilizing the specific apparatus for supplying water and having preferable number of nozzles, shape and pressure together with a pure water. According to arrangement of the process, the subject may be removed in the water supplying section in place of the chemical, that is, the cleaning material tank thereby to improve the life-time of the cleaning material. Also, the tank can be mounted by an appropriate filtering system to reduce defects such as black spots and to prevent reduction of cleaning capacity by increasing contact area between the cleaning material and the panel.

### EXAMPLE 2

### Supersonic Cleaning

The cleaning material according to the present invention was applied to remove the fluorescent film, the graphite film and the intermediate layer and the metallic reflection film adhered to a panel in a process of cleaning and reproducing the panel by applying the cleaning material and the supersonic wave. The cleaning material was LG-Cleaner with 10% content, and was applied to the panel at 40° C. With regard to the supersonic wave apparatus, it comprises a vibration section having a structure for removal of a resonance part and an air-conditioning system to control rotation and angles of the panel. The apparatus is featured of utilizing a length for applying an initial peak value of the supersonic wave as the distance between the vibration section and the panel.

### EXAMPLE 3

### Dipping Method

The cleaning material according to the present invention was applied to remove the fluorescent film, the graphite film and the intermediate layer and the metallic reflection film adhered to a panel in a process of cleaning and reproducing the panel. First of all, the cleaning material was supplied into an existing large tank, following by dipping the panel and connecting a pipe to provide and/or generate air bubbles and/or foam thereby to remove impurities.

Moreover, the present invention can replace a strong acid such as the fluoric acid with a weak acid such as the ammonium fluoride or similar, as well as considerably reduce amount of the fluoric acid consumed to prevent environmental contamination and damage of panel.

The cleaning process accomplished by the cleaning material according to the present invention is explained as follows:

Typically, the chemicals can be applied to even a new panel other than the reused product when passing the panel to the cleaning process in order to eliminate impurities and pits inside the panel, especially made of glass material to obtain a stable application quality.

Such process will be specifically illustrated by way of a following embodiment in relation to a subject coated all over the metallic reflection film to be cleaned among the reused products.

1. The inventive cleaning material is firstly mixed with a pure water to become a desirable content;

2. By supplying tap water, it is compensated temperature of the panel and followed by loosing a structure between the metallic reflection film and the intermediate layer;

3. Applying the cleaning material of the present invention for a certain period of time to remove the metallic reflection film. In particular, the metallic reflection film at a non-efficient side being eliminated;

4. A specific cleaning material for discarding the intermediate layer can remove the intermediate layer at the non-efficient side;

5. Through the cleaning process by the tap water supplied, residual chemicals and/or a subject to be cleaned at an efficient side are removed;

6. Applying the inventive cleaning chemical, being removed both of the graphite film and the fluorescent film at the respective efficient/non-efficient sides; and

7. With the tap water supplied and the pure water together, it is conducted the rinsing process.

According to the steps illustrated above, the reused panel product is under the cleaning process. Introduction order or details of the cleaning process are not particularly limited, but are able to be changed and/or modified dependent on subjects to be cleaned or other circumstances, for example, parameters such as pressure at spraying the chemicals, angle, number, shape or location of nozzles or distance between nozzles should be preferably controlled.

As illustrated above, the cleaning material and the cleaning method according to the present invention express the following functional effects.

First of all, the inventive cleaning material breaks the surface tension between the panel and the impurities by comprising the builder, whereby the present invention has advantages of reduction of aging of the cleaning material; reduction of sludge generated thereby to preserve a certain purity of the cleaning material and to use it for a long time; therefore, can save the costs for cleaning and accomplish the environmentally friendship treatment process.

Second, because of utilizing the mixed acid, a regular etching against a glass surface is improved to ensure removal of pits simultaneously with remarkably reducing panel corrosion due to no use of fluoric acid, whereby the present invention enhances the application efficiency including the cutting feature.

Third, the present invention noticeably improves the cleaning ability to lead improvements of processing time, panel size to be applied and productivity, and eliminates failures involving portions not to be cleaned, defects and/or damages of the panel caused by the strong fluoric acid or by means of high-pressure cleaner.

Fourth, compared to previously known art, the present invention is more advantageous in the aspects of noise, space, repair of equipments or so forth.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A cleaning material of a color cathode ray tube panel, comprising an acidic water-soluble solution and a surfactant.

2. The cleaning material according to claim 1, wherein the acidic water-soluble solution is at least one selected from a group consisting of ammonium fluoride and sodium fluoride.

3. The cleaning material according to claim 2, wherein the acidic water-soluble solution further comprises the ammonium fluoride added by the sodium fluoride.

4. The cleaning material according to claim 1, wherein the cleaning material further comprises inorganic acid.

5. The cleaning material according to claim 4, wherein the inorganic acid is at least one selected from a group consisting of phosphoric acid, nitric acid, hydrochloric acid and sulfuric acid.

6. The cleaning material according to claim 5, wherein the inorganic acid further comprises the phosphoric acid added by the nitric acid.

7. The cleaning material according to claim 1, wherein the surfactant in the cleaning material is at least one selected from a group consisting of alkyl benzene sulfonate, sodium xylene sulfonate and glycol ether.

8. The cleaning material according to claim 1, wherein the cleaning material further comprises a builder.

9. The cleaning material according to claim 8, wherein the builder is at least one selected from a group consisting of diethylene glycol ether and diethylene butyl glycol ether.

10. A cleaning material of a color cathode ray tube panel having fluorescent film, graphite film, intermediate layer or metallic reflection film inside, comprising an acidic water-soluble solution, an inorganic acid, a surfactant and a builder.

11. The cleaning material according to claim 10, wherein the cleaning material has pH value ranged of 2 to 5.

12. The cleaning material according to claim 10, wherein the cleaning material has a specific gravity ranged of 1.0 to 1.5.

13. The cleaning material according to claim 10, wherein the cleaning material comprises 3 to 30% by weight of ammonium fluoride, 1 to 25% by weight of inorganic acid, 1 to 10% by weight of sodium fluoride, 1 to 10% by weight of surfactant and 1 to 5% by weight of builder in a water-soluble solution.

14. A process to use a cleaning material of a color cathode ray tube panel having fluorescent film, graphite film, intermediate layer or metallic reflection film inside, the cleaning material comprising an acidic water-soluble solution, an inorganic acid and a surfactant, wherein the process comprises steps of:
mixing the cleaning material with a pure water to reach a desirable concentration;
applying the mixed cleaning material to the panel and leaving it for a desirable period of time sufficient to remove the metallic reflection film;
applying another cleaning material for eliminating the intermediate layer to remove the intermediate layer at a non-efficient side;
clearing residual chemicals and removing the metallic reflection film at an efficient side by washing the panel with a tap water;
applying the mixed cleaning material to the panel again to remove the graphite film and the fluorescent film at both of the efficient and the non-efficient sides; and
conducting a rinsing process with the tap water and the pure water.

15. A process to use a cleaning material of a color cathode ray tube panel having fluorescent film, graphite film, intermediate layer or metallic reflection film inside, the cleaning material comprising an acidic water-soluble solution, an inorganic acid and a surfactant, wherein the process comprises steps of:
diluting the cleaning material with a pure water; and
applying a supersonic field to the panel to remove the fluorescent film adhered to the panel.

16. A process to use a cleaning material of a color cathode ray tube panel having fluorescent film, graphite film, intermediate layer or metallic reflection film inside, the cleaning material comprising an acidic water-soluble solution, an inorganic acid and a surfactant, wherein the process comprises steps of:
diluting the cleaning material with a pure water; and
generating air-bubbles in the cleaning material to remove the fluorescent film adhered to the panel.
